(19) United States
(12) Patent Application Publication
(10) Pub. No.: US 2025/0077875 A1
(43) Pub. Date: Mar. 6, 2025

(54) METHODS, SYSTEMS, AND COMPUTER READABLE MEDIA FOR CAUSAL TRAINING OF PHYSICS-INFORMED NEURAL NETWORKS

(71) Applicant: The Trustees of the University of Pennsylvania, Philadelphia, PA (US)

(72) Inventors: Paris Georgios Perdikaris, Philadelphia, PA (US); Sifan Wang, Cary, NC (US)

(21) Appl. No.: 18/721,210

(22) PCT Filed: Feb. 28, 2023
(86) PCT No.: PCT/US2023/014053

§ 371 Date: Jun. 18, 2024

Related U.S. Application Data
(60) Provisional application No. 63/317,438, filed on Mar. 7, 2022.

(51) Int. Cl. G06N 3/0895

(52) U.S. Cl. CPC G06N 3/0895

(57) ABSTRACT

Methods, systems, and computer-readable media for causal training of physics-informed neural networks (PINNs). The shortcoming of conventional PINNs may be due to the inability of existing PINNs formulations to respect the spatio-temporal causal structure that is inherent to the evolution of physical systems. This is a fundamental limitation and a key source of error that ultimately steers FINN models to converge towards erroneous solutions. Methods can include a re-formulation of PINNs loss functions that can explicitly account for physical causality during model training. This modification alone is enough to introduce significant accuracy improvements, allowing us to tackle problems that have remained elusive to PINNs.

### CROSS-REFERENCE TO RELATED APPLICATIONS

This application claims benefit of U.S. Provisional Application Ser. No. 63/317,438, filed on Mar. 7, 2022, the disclosure of which is incorporated herein by reference in its entirety.

### GOVERNMENT INTEREST

This invention was made with government support under DESC0019116, DE-AR0001201 awarded by the U.S. Department of Energy and FA9550-20-1-0060 awarded by the U.S. Air Force. The government has certain rights in the invention.

### TECHNICAL FIELD

This specification relates generally to machine learning and in particular to methods, systems, and computer readable media for causal training of physics-informed neural networks (PINNs).

### BACKGROUND

Physics-informed neural networks (PINNs) is a deep learning framework that enables the synthesis of observational data and physics-based governing laws, to expediently predict the outcomes of complex physical and engineering systems. While the popularity of PINNs is steadily rising, PINNs have not been successful in simulating dynamical systems whose solution exhibits multi-scale, chaotic or turbulent behavior. These are not pathological corner cases, but cases that are extremely relevant across a multitude of realistic applications in science and engineering.

### SUMMARY

The shortcoming of conventional PINNs may be due to the inability of existing PINNs formulations to respect the spatio-temporal causal structure that is inherent to the evolution of physical systems. This is a fundamental limitation and a key source of error that ultimately steers PINN models to converge towards erroneous solutions. This document describes a reformulation of PINNs loss functions that can explicitly account for physical causality during model training. This modification alone is enough to introduce significant accuracy improvements, allowing us to tackle problems that have remained elusive to PINNs.

The subject matter described herein may be implemented in hardware, software, firmware, or any combination thereof. As such, the terms “function” or “node” as used herein refer to hardware, which may also include software and/or firmware components, for implementing the feature(s) being described. In some exemplary implementations, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF DRAWINGS

FIG. 1A is a block diagram of an example system for training at least one PINN using training samples.

FIG. 1B illustrates the Allen-Cahn equation: Top: Reference solution versus the prediction of a trained conventional physics-informed neural network. The resulting relative L² error is 49.87%. Bottom: Comparison of the predicted and reference solutions corresponding to the three temporal snapshots at t=0.0,0.5,1.0.

FIG. 2 further illustrates the Allen-Cahn equation: Left: Loss convergence of training a conventional physics-informed neural network for 2×10⁵ iterations. Middle: Temporal residual loss L(t,θ) at different iteration of the training. Right: Temporal convergent rate at different iteration of the training.

FIG. 3 further illustrates the Allen-Cahn equation: Top: Reference solution versus the prediction of a trained physics-informed neural network using Algorithm 1. The resulting relative L² error is 1.43e−03. Bottom: Comparison of the predicted and reference solutions corresponding to the three temporal snapshots at t=0.0,0.5,1.0.

FIG. 4 further illustrates the Allen-Cahn equation: Left: Loss convergence of training a physics-informed neural network using Algorithm 1. Middle: Temporal residual loss L(t,θ) at different iteration of the training. Right: Temporal weights at different iteration of the training.

FIG. 5 shows results for the Lorentz system: Comparison between the predicted and reference solutions.

FIG. 6 shows results for the Kuramoto-Sivashinsky equation (regular): Top: Reference solution versus the prediction of a trained physicsinformed neural network using Algorithm 1. The resulting relative L² error is 3.49e-04. Bottom: Comparison of the predicted and reference solutions corresponding to the three temporal snapshots at t=0,0.5,1.0.

FIG. 7 shows results for the Kuramoto-Sivashinsky equation (regular): Left: Timing of evaluating the loss function of a PINN model with different number of layers. Right: Timing of evaluating the forward pass of a PINN model with different batch sizes.

FIG. 8 shows results for the Kuramoto-Sivashinsky equation: Left: Relative L² errors of Case I (regular). Right: Relative L² errors of Case II (chaotic).

FIG. 9 shows results for the Kuramoto-Sivashinsky equation (chaotic): Top: Reference solution versus the prediction of a trained physicsinformed neural network using Algorithm 1. The resulting relative L² error is 2.26e−02. Bottom: Comparison of the predicted and reference solutions corresponding to the three temporal snapshots at t=0,0.25,0.5.

FIG. 10 shows results for the Kuramoto-Sivashinsky equation (chaotic): Reference solution versus the prediction of a trained physicsinformed neural network using Algorithm 1. The initial condition is u₀(x)=cos(x)(1+sin(x)).

FIG. 11 shows results for the Navier-Stokes equation: Representative snapshot of the predicted velocity and vorticity versus the corresponding reference solution at t=1.

FIG. 12 shows results for the Navier-Stokes equation: Predicted spectrum energy versus the reference spectrum energy at different snapshots t=0.0,0.5,1.0.

FIG. 13 shows results for the Navier-Stokes equation: Predicted spectrum energy versus the reference spectrum energy at different snapshots t=0.0,0.5,1.0.

FIG. 14 shows results for Parallel Performance: Left: Strong Scaling: Keeping the total-batch size for the problem fixed, we evaluate the speedup obtained when the batch is split across multiple devices. Centre: Weak Scaling: Keeping the batch-size on each GPU fixed, we report the efficiency of scaling by dividing the time taken on a single device over the time taken on n-devices. Right: Effect of batch-size: L² error for models trained till t=0.1 using Nₜ and Nₓ points per iteration in the temporal and spatial domain respectively.

### DETAILED DESCRIPTION

This specification describes methods, systems, and computer readable media for training physics-informed neural networks. Physicsinformed neural networks (PINNs) are a class of neural networks that incorporate physical principles and laws into the training process. These networks are used to solve partial differential equations (PDEs) that describe physical phenomena, such as fluid dynamics, electromagnetism, and mechanics.

PINNs can involve combining the power of deep neural networks with the accuracy of physical models to make predictions and simulate physical systems. In other words, these models use data-driven techniques to approximate the solution of a PDE, while also enforcing physical constraints.

In PINNs, the neural network architecture is designed to take input variables, such as spatial or temporal coordinates, as well as other variables related to the problem at hand. These inputs can then be processed by a series of hidden layers, and the output is an approximation of the solution of the PDE.

During the training process, PINNs can use a combination of supervised learning and unsupervised learning. The supervised learning part of the training involves using the data to minimize the error between the neural network output and the true solution of the PDE at a set of selected points. The unsupervised learning part involves minimizing the residual error, which is the difference between the PDE and the neural network output.

PINNs can be used in a variety of applications, including fluid mechanics, solid mechanics, and electromagnetism. They can greatly reduce the computational cost of simulating physical systems, while also increasing the accuracy of the results.

Here are some examples of the applications of PINNs:
Fluid Dynamics: PINNs have been used to simulate fluid flow in complex geometries, such as the flow around a wing, a jet engine, or a wind turbine. They can also be used to optimize the design of flow devices, such as aerodynamic shapes or heat exchangers.
Solid Mechanics: PINNs have been applied to solve problems related to solid mechanics, such as stress analysis, deformation, and fracture mechanics. For example, they can be used to predict the stress distribution in a mechanical component or the deformation of a structure under external loads.
Electromagnetism: PINNs have been used to solve Maxwell's equations, which describe the behavior of electromagnetic fields. They can be used to design and optimize antennas, electromagnetic waveguides, and microwave circuits.
Quantum Mechanics: PINNs have been used to simulate the behavior of quantum systems, such as the Schrödinger equation. They can be used to design and optimize quantum devices, such as quantum computers or sensors.
Medical Imaging: PINNs have been used to solve inverse problems in medical imaging, such as computed tomography (CT), magnetic resonance imaging (MRI), and ultrasound imaging. They can be used to improve the resolution and quality of medical images, and to reduce the radiation dose and acquisition time.
Climate Science: PINNs have been used to simulate climate models, such as ocean circulation and atmospheric dynamics. They can be used to predict the evolution of the Earth's climate, and to design and optimize climate mitigation and adaptation strategies.

In general, PINNs can be used in any application where PDEs are used to model physical phenomena, and where there is a need for accurate and efficient simulation or prediction. The methods and system described in this document can be embodied in one or more software modules to be incorporated into numerous PINN models (e.g. a software library) for applications such as design optimization, optimal control, and building Digital Twins.

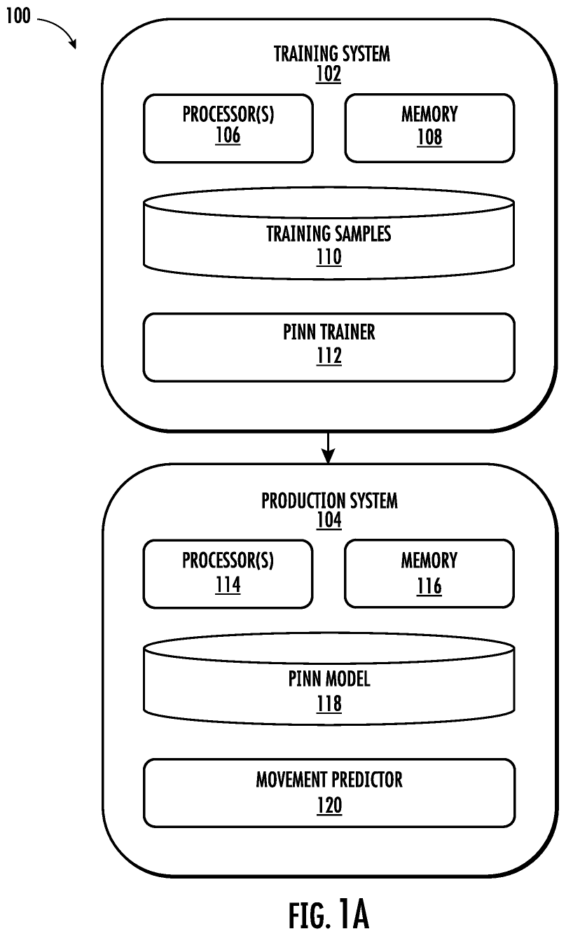

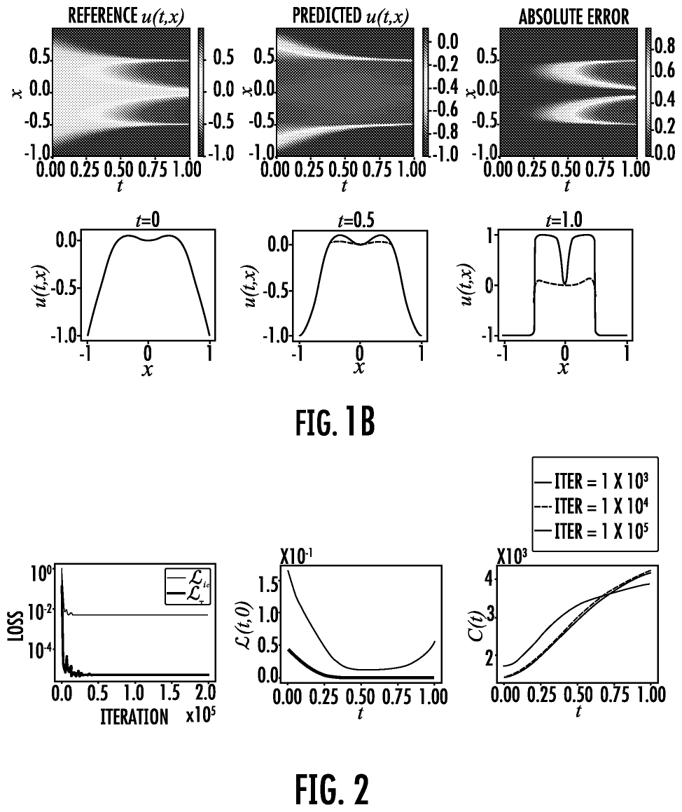

FIG. 1A is a block diagram of an example system 100 for training at least one PINN using training samples. The system 100 includes two computer systems, a training system 102 and a production system 104; however, in general, a single computer system or multiple additional computer systems could perform the functions of the two computer systems 102 and 104.

The training system 102 includes one or more processors 106 and memory 108 storing instructions for the processors 106. The training system 102 stores training samples 110 and a PINN trainer 112 configured to train a PINN using the training samples 110. The production system 104 includes one or more processors 114 and memory storing instructions for the processors 114. The production system 104 stores a PINN model 118 that is output from the PINN trainer 112. The production system 104 includes a movement predictor 120 configured for predicting, using the PINN model 118, movement of at least one component of a mechanical system.

The training samples 110 can include, for example, a combination of labeled and unlabeled training samples. The labeled samples include input-output pairs that are used to train the neural network to learn the relationship between the input and output variables. These labeled samples may be obtained from experimental measurements or simulations.

In addition to the labeled samples, the training samples 110 can include unlabeled samples that encode prior knowledge about the underlying physics. These samples can include, for example, spatial or temporal patterns that are characteristic of the mechanical system being modeled. For example, in fluid dynamics, the unlabeled samples might include velocity or pressure fields that satisfy the Navier-Stokes equations. In structural mechanics, the unlabeled samples might include deformation or stress fields that satisfy the equations of elasticity.

These unlabeled samples can be used to enforce physical constraints on the learned model, and can be incorporated into the training process in several ways. For example, they can be used to regularize the neural network during training, or to generate synthetic training data to augment the labeled samples.

The PINN trainer 112 can use any appropriate algorithm for training the PINN model 118. For example, the PINN trainer 112 can perform one or more of the following steps in training the PINN model 118 to predict movement of at least one physical component of a mechanical system:
1. Data collection and preprocessing: First, data is collected from the mechanical system, which may include sensor measurements of position, velocity, and other relevant variables. The data is preprocessed and cleaned, and any missing values are imputed.
2. Model formulation: Next, a PINN is formulated to predict the position and velocity of the mechanical component as a function of time. The input variables to the model may include time, position, velocity, and other relevant variables. The output variables are the predicted position and velocity of the mechanical component.
3. Training and validation: The PINN is trained on the training samples 110. The unlabeled samples may include physical constraints such as the equations of motion that govern the movement of the mechanical component. The model is trained using an optimization algorithm, such as stochastic gradient descent, to minimize the loss function, which measures the error between the predicted and true output values. The model is validated on a separate dataset to ensure that it is able to generalize to new, unseen data.

The movement predictor 120 can then use the PINN model 118 to predict movement of a physical component of the mechanical system. For example, once the PINN model 118 is trained, it can be used to predict the position and velocity of the mechanical component at any future time. The input variables are fed into the model 118, and the output variables are predicted using the trained neural network. The predicted values can be compared with actual measurements to assess the accuracy of the model 118. The model 118 can be refined and improved by tuning hyperparameters, such as the number of layers or nodes in the neural network, or by adjusting the regularization strength or learning rate. The model 118 can also be updated with new data as it becomes available, to improve the accuracy of the predictions.

In some examples, the PINN trainer 112 is configured for training the PINN model 118 by differentiating at least one partial differential equation characterizing a time-dependent behavior of a mechanical system; and minimizing a loss function specifying an error of the physics-informed neural network with respect to the training samples by assigning weights in a residual loss value to account for physical causality in the partial differential equation. Examples of training the PINN model 118 in this manner are described further below in the following paper, “Respecting Causality Is All You Need For Training Physics-informed Neural Networks.”

### Respecting Causality is all You Need for Training Physics-Informed Neural Networks

While the popularity of physics-informed neural networks (PINNs) is steadily rising, to this date PINNs have not been successful in simulating dynamical systems whose solution exhibits multi-scale, chaotic or turbulent behavior. In this work we attribute this shortcoming to the inability of existing PINNs formulations to respect the spatio-temporal causal structure that is inherent to the evolution of physical systems. We argue that this is a fundamental limitation and a key source of error that can ultimately steer PINN models to converge towards erroneous solutions. We address this pathology by proposing a simple re-formulation of PINNs loss functions that can explicitly account for physical causality during model training. We demonstrate that this simple modification alone is enough to introduce significant accuracy improvements, as well as a practical quantitative mechanism for assessing the convergence of a PINNs model. We provide state-of-the-art numerical results across a series of benchmarks for which existing PINNs formulations fail, including the chaotic Lorenz system, the Kuramoto-Sivashinsky equation in the chaotic regime, and the NavierStokes equations in the turbulent regime. To the best of our knowledge, this is the first time that PINNs have been successful in simulating such systems, introducing new opportunities for their applicability to problems of industrial complexity.

### INTRODUCTION

Physics-informed neural networks (PINNs) have emerged as a promising framework for synthesizing observational data and physical laws across diverse applications in science and engineering [1, 2, 3, 4, 5, 6, 7, 8]. However, it is well known that PINNs often face severe difficulties and even fail to tackle problems whose solution exhibits highly nonlinear, multi-scale, or chaotic behavior [9, 10]. Over the last few years, a series of extensions to the original formulation of Raissi et al. have been proposed with the sole goal of enhancing the accuracy and robustness of PINNs in tackling increasingly more challenging problems. Such extensions include, but are not limited to, novel optimization algorithms for adaptive training [12, 13, 14, 15], adaptive algorithms for selecting batches of training data [16, 17], novel network architectures [12, 9, 18, 19, 20], domain decomposition strategies [21, 22], new types of activation functions [23], and sequential learning strategies [16, 24, 25]. Although these techniques have been successful in introducing some improvements in terms of trainability and accuracy, there still exists a vast suite of problems that remain elusive to PINNs. Examples of such problems include systems whose behavior exhibits strong nonlinearity, broadband energy spectra, and high sensitivity to initial conditions, such as the chaotic Kuramoto-Sivishinski equation and the Navier-Stokes equations in the turbulent regime. These are not pathological corner cases, but cases that are extremely relevant across a multitude of realistic scenarios in science and engineering. There is therefore a pressing need for understanding why PINNs fall short in such scenarios, and how they can be improved in order to overcome the challenges that currently limit their success to relatively simple problems.

Physical systems are known to possess an inherent causal structure. Consider for example a linear wave with some initial velocity that is spreading out with a speed c across a homogeneous medium [26]. It is well-understood that, although a part of the wave may lag behind (if there is an initial velocity), no part can travel faster than speed c. This assertion encapsulates the so-called principle of causality that dictates how local changes in the initial/boundary data of a spatio-temporal dynamical system is reflected in its corresponding states at later times [26]. Specific to hyperbolic partial differential equations (PDEs), such as the wave equation, this principle underpins the formulation of the method of characteristics that provides a rigorous set of analytical and numerical tools for efficiently tackling initial value problems. Although characterizing how information propagates in general nonlinear PDEs is a challenging task, basic principles of causality such as temporal precedence and covariation (i.e. statistical dependency between variables that are generated by coupled time evolution) are still expected to hold. This causal structure is also clearly reflected in classical numerical methods, where a PDE is typically discretized in time by sequential algorithms which ensure that the solution at time t is fully resolved before approximating the solution at time t+Δt. Strikingly, this notion of temporal dependence is absent in most continuous-time PINNs formulations (see e.g. [28, 29, 30, 21, 12, 13, 23]). In fact, continuous-time PINNs trained by gradient descent are implicitly biased towards first approximating PDE solutions at later times, before even resolving the initial conditions, therefore profoundly violating temporal causality. Consequently, it is no surprise that such formulations are fragile and often fail to simulate forward problems, especially in cases where the target solutions exhibit strong dependence on initial data (e.g. chaotic systems). Recent studies [16, 24, 25] have proposed remedies to this issue by empirically introducing sequential training strategies, yet a concrete justification of why such strategies appear to be effective is still missing.

This document describes methods, systems, and computer readable media configured for respecting physical causality during the training of continuous-time PINNs. Our specific contributions can be summarized as:
We reveal an implicit bias suggesting that continuous-time PINNs models can violate causality, and hence are susceptible to converge towards erroneous solutions.
We put forth a simple re-formulation of PINNs loss functions that allows us to explicitly respect the causal structure that characterizes the solution of general nonlinear PDEs.
Strikingly, we demonstrate that this simple modification alone is enough to introduce significant accuracy improvements, allowing us to tackle problems that have remained elusive to PINNs.
We provide a practical quantitative criterion for assessing the training convergence of a PINNs model.
We examine a collection of challenging benchmarks for which existing PINNs formulations fail, and demonstrate that the proposed causal training strategy leads to state-of-the-art results.

The PINNs described in this document have been successful in simulating systems such as the chaotic Lorenz system, the Kuramoto-Sivashinsky equation in the chaotic regime, and the Navier-Stokes equations in the turbulent regime, introducing new opportunities for their applicability to problems of industrial complexity.

### Physics-Informed Neural Networks (PINNs)

Problem setup: We begin with a brief overview of physics informed neural networks (PINNs) in the context of inferring the solutions of PDEs. Generally, we consider PDEs taking the form

$${u}_{t} + N [ u ] = 0 , t ∈ [ 0 , T ] , x ∈ Ω , \qquad ( 2.1 )$$

subject to the initial and boundary conditions

$$u ( 0 , x ) = g ( x ) , x ∈ Ω , \qquad ( 2.2 )$$

$$B [ u ] = 0 , t ∈ [ 0 , T ] , x ∈ \partial Ω , \qquad ( 2.3 )$$

where N[⋅] is a linear or nonlinear differential operator, and B[⋅] is a boundary operator corresponding to Dirichlet, Neumann, Robin, or periodic boundary conditions. In addition, u describes the unknown latent solution that is governed by the PDE system of equation 2.1.

Following the original work of Raissi et al. [11], we proceed by representing the unknown solution u(x,t) by a deep neural network u_{θ}(x,t), where θ denotes all tunable parameters of the network (e.g., weights and biases). Then, a physics-informed model can be trained by minimizing the following composite loss function

$$L ( θ ) = {λ}_{ic} Lic ( θ ) + {λ}_{bc} Lbc ( θ ) + {λ}_{r} Lr ( θ ) , \qquad ( 2.4 )$$

$$where$$

$${L}_{ic} ( θ ) = \frac{1}{{N}_{ic}} {\sum }_{i = 1}^{{N}_{ic}} {\vert {u}_{θ} ( 0 , {x}_{ic}^{i} ) - g ( {x}_{ic}^{i} ) \vert}^{2} , \qquad ( 2.5 )$$

$${L}_{bc} ( θ ) = \frac{1}{{N}_{bc}} {\sum }_{i = 1}^{{N}_{bc}} {\vert ℬ [ {u}_{θ} ] ( {t}_{bc}^{i} , {x}_{bc}^{i} ) \vert}^{2} , \qquad ( 2.6 )$$

$${L}_{r} ( θ ) = \frac{1}{{N}_{r}} {\sum }_{i = 1}^{{N}_{r}} {\vert \frac{\partial {u}_{θ}}{\partial t} ( {t}_{r}^{i} , {x}_{r}^{i} ) + 𝒩 [ {u}_{θ} ] ( {t}_{r}^{i} , {x}_{r}^{i} ) \vert}^{2} . \qquad ( 2.7 )$$

Here {x_{ic}ⁱ}ᵢ₌₁^{N}^{ᵢₑ},{t_{bc}ⁱ,x_{bc}ⁱ}ᵢ₌₁^{N}^{_{bc}} and can be the vertices of a fixed mesh or points that are randomly sampled at each iteration of a gradient descent algorithm. Notice that all required gradients with respect to input variables or network parameters θ can be efficiently computed via automatic differentiation [31]. Moreover, the hyper-parameters {λ_{ic}, λ_{bc}, λᵣ} allow the flexibility of assigning a different learning rate to each individual loss term in order to balance their interplay during model training. These weights may be user-specified or tuned automatically during training [12, 13].

An illustrative example: To motivate the proposed methods, let us study a representative case with which conventional PINN models are known to struggle. To this end, consider the one-dimensional Allen-Cahn equation

$$\begin{matrix}{u}_{t} - 0.0001 {u}_{xx} + 5 {u}^{3} - 5 u = 0 , & t ∈\end{matrix} [ 0 , 1 ] , \times ∈ [ - 1 , 1 ] , \qquad ( 2.8 )$$

$$u ( x , 0 ) = {x}^{2} cos ( π x ) , \qquad ( 2.9 )$$

$$u ( t , 1 ) = u ( t , 1 ) , \qquad ( 2.1 )$$

$${u}_{x} ( t , 1 ) = {u}_{x} ( t , 1 ) . \qquad ( 2.11 )$$

This example is difficult to directly solve with the original continuous-time formulation of Raissi et al. [11], and has been recently studied by Wight et. al. and McClenny et. al. who developed adaptive re-sampling and weighting algorithms, respectively, to improve the PINNs prediction.

Following the setup discussed in these studies [14, 16], we represent the latent variable u by a fully-connected neural network u_{θ} with tan h activation function, 4 hidden layers and 128 neurons per hidden layer. To further simplify the training objective 2.4, we also strictly impose the periodic BCs by embedding the input coordinates into Fourier expansion using equation 4.8 with m=10. Then the loss function 2.4 can be reduced to

$$L ( θ ) = {λ}_{ic} Lic ( θ ) + {λ}_{r} Lr ( θ ) , \qquad ( 2.12 )$$

where Lic(θ) and Lr(θ) are defined exactly the same as in 2.5 and 2.7. For simplicity, we create a uniform mesh of size 100×256 in the computational domain [0,1]×[−1,1], yielding N_{ic}=256 initial points and Nᵣ=25600 collocation points for enforcing the PDE residual. We also choose λ_{ic}=100,λᵣ=1 for better enforcing the initial condition.

We proceed by training the resulting PINN model via full-batch gradient descent using the Adam optimizer for 2×10⁵ iterations. As shown in FIG. 1B, even when the periodic boundary conditions are enforced exactly, our conventional PINN model is unable to learn the accurate solution for this example. One can also observe that the predicted solution seems to get stuck at some intermediate state and cannot be further refined to provide an accurate approximation to the ground truth. This is consistent with the left panel of FIG. 2 where the loss functions rapidly decrease in the first few thousand training iterations, and then barely change for the rest of training, implying that the neural network gets trapped in an erroneous local minimum. Unfortunately, such problematic behavior is not a rare event, but rather a common outcome for PINNs, especially when solving transient problems [13, 24].

PINNs can violate physical causality: To explore the underlying reasons behind this failed case study, let us closely examine the definition of the residual loss Lr. Before doing so, we will slightly change our notation for convenience. Suppose that 0=t₁<t₂< . . . <t_{Nt}=T discretizes the temporal domain, and {xⱼ}ⱼ₌₁^{N}^{ₓ} discretizes the spatial domain Ω. For this example, {tᵢ}ᵢ₌₁^{N}^{ₜ} and {xⱼ}ⱼ₌₁^{N}^{ₓ} are uniformly spaced meshes in [0,1] and [−1,1], respectively. Now for a given spatial discretization {xⱼ}ⱼ₌₁^{N}^{ₓ}, we define the temporal residual loss as

$${ℒ}_{r} ( t , θ ) = \frac{1}{{N}_{x}} {\sum }_{j = 1}^{{N}_{x}} {\vert \frac{\partial {u}_{θ}}{\partial t} ( t , {x}_{j} ) + 𝒩 [ {u}_{θ} ] ( t , {x}_{j} ) \vert}^{2} . \qquad ( 2.13 )$$

Then, the residual loss 2.7 can be rewritten as

$$\begin{matrix}{ℒ}_{r} ( θ ) = \frac{1}{{N}_{t}} {\sum }_{i = 1}^{{N}_{t}} {ℒ}_{r} ( {t}_{i} , θ ) & ( 2.14 ) \\ = \frac{1}{{N}_{t} {N}_{x}} {\sum }_{i = 1}^{{N}_{t}} {\sum }_{j = 1}^{{N}_{x}} {\vert \frac{\partial {u}_{θ}}{\partial t} ( {t}_{i} , {x}_{j} ) + 𝒩 [ {u}_{θ} ] ( {t}_{i} , {x}_{j} ) \vert}^{2} . & ( 2.15 )\end{matrix}$$

Next, we discretize

$$\frac{\partial {u}_{θ}}{\partial t}$$

using the forward Euler scheme [33]. For any 1≤i≤Nₜ−1, L(tᵢ,θ) can be approximated by

$$\begin{matrix}{ℒ}_{r} ( t , θ ) \approx \frac{1}{{N}_{x}} {\sum }_{j = 1}^{{N}_{x}} {\vert \frac{{u}_{θ} ( {t}_{i} , {x}_{j} ) - {u}_{θ} ( {t}_{i - 1} , {x}_{j} )}{Δ t} + 𝒩 [ {u}_{θ} ] ( {t}_{i - 1} , {x}_{j} ) \vert}^{2} \\ \approx \frac{\vert Ω \vert}{Δ {t}^{2}} {\int }_{Ω} {\vert {u}_{θ} ( {t}_{i} , x ) - {u}_{θ} ( {t}_{i - 1} , x ) + Δ t 𝒩 [ {u}_{θ} ] ( {t}_{i - 1} , x ) \vert}^{2} dx\end{matrix} \qquad ( 2.16 )$$

From the above expression, we immediately obtain that the minimization of L(tᵢ,θ) should be based on the correct prediction of both u_{θ}(tᵢ,x) and u_{θ}(tᵢ₋₁,x), while the original formulation of equation 2.7 tends to minimize all L(tᵢ,θ) simultaneously. As a result, by using equation 2.7, the residual loss Lr(tᵢ,θ) will be minimized even if the prediction at tᵢ and previous times is inaccurate. This behavior inevitably violates temporal causality, making the PINN model susceptible to learning erroneous solutions.

This conclusion is further confirmed by the middle panel of FIG. 2 where we plot the temporal residual loss of Allen-Cahn equation at different iterations of training. As expected, the residual is quite large near the initial state and rapidly decays to nearly zero after t=0.5. We emphasize that the PDE temporal residual of small magnitude is meaningful only if the PINN model is well optimized and able to yield accurate predictions at the previous time steps.

An undesirable implicit bias: To provide a deeper understanding of the fact that PINNs may violate temporal causality, we analyze their training dynamics through the lens of their empirical Neural Tangent Kernel (NTK) [34, 13]. Specifically, for every Lr(t,θ) (Equation 2.13), we can define the empirical NTK K_{θ}(t)∈R^{Nx×Nx} whose ij-th entry is given by [13]

$${K}^{{θ ( t )}_{ij}} = 〈 \frac{\partial {ℛ}_{θ}}{\partial θ} ( t , {x}_{i} ) , \frac{\partial {ℛ}_{θ}}{\partial θ} ( t , {x}_{j} ) 〉 , \qquad ( 2.17 )$$

where Rθ is the corresponding PDE residual defined by

$$\begin{matrix}{ℛ}_{θ} ( t , x ) = \frac{\partial {u}_{θ}}{\partial t} ( t , x ) + 𝒩 [ {u}_{θ} ] ( t , x ) , & i , j = 1 , 2 , …\end{matrix} , {N}_{x} . \qquad ( 2.18 )$$

As demonstrated by Wang et. al. [13], the eigenvalues of K_{θ}(t) determine the convergence rate of each Lr(t,θ) contributing to the total residual loss Lr(θ). Specifically, larger eigenvalues implies faster convergence rate. Following [13], we introduce the definition:
Definition 2.1. For any given t∈[0, 7], the temporal convergence rate C(t) of Lr(t,θ) is defined by

$$C ( t ) = \frac{{\sum }_{k = 1}^{{N}_{t}} {λ}_{k} ( t )}{{N}_{t}} = \frac{Trace ( {K}_{θ} ( t ) )}{{N}_{t}} \qquad ( 2.19 )$$

where {λₖ(t)}ₖ₌₁^{N}^{ₜ} are the eigenvalues of K_{θ}(t).

Equipped with definition 2.19, we visualize C(t) at different iterations during the training of our PINNs model for solving Allen-Cahn equation. In the right panel of FIG. 2, it can be seen that C(t) is greater if t is greater, indicating that the network is biased towards minimizing the temporal residual Lr(t,θ) for larger t. This reveals an undesirable implicit bias of continuous-time PINN models trained via gradient descent, suggesting that such models can profoundly violate the temporal causal structure that is inherent to time-dependent PDE systems. We argue that this inherent pathology of PINNs is the key underlying reason behind their inability to simulate transient problems that exhibit strong temporal correlations and sensitivity to initial data.

In the next section we put forth a remarkably simple and effective strategy for explicitly respecting physical causality during the training phase PINNs.

### Causal Training for Physics-Informed Neural Networks

A simple re-formulation: Based on our findings in the previous section, it is natural to ask how can we respect physical causality when solving PDEs with PINNs? We answer this question by introducing a simple re-formulation of the PINNs training objective that can explicitly account for the missing causal structure. To this end, we define a weighted residual loss

$${ℒ}_{r} ( θ ) = \frac{1}{{N}_{t}} {\sum }_{i = 1}^{{N}_{t}} {w}_{i} {ℒ}_{r} ( {t}_{i} , θ ) . \qquad ( 3.1 )$$

We recognize that the weights wᵢ should be large—and therefore allow the minimization of Lr(tᵢ,θ)—only if all residuals { [symbol] (tₖ,θ)}ₖ₌₁ⁱ before tare minimized properly, and vice versa. This can be achieved by expressing the weights was

$${w}_{i} = exp ( - ϵ {\sum }_{k = 1}^{i - 1} {ℒ}_{r} ( {t}_{k} , θ ) ) , for i = 2 , 3 , … , {N}_{t} , \qquad ( 3.2 )$$

where ϵ will be referred to as a causality parameter that controls steepness of the weights wᵢ (see below for a more detailed discussion). As such, the weighted residual loss can be written as

$${ℒ}_{r} ( θ ) = \frac{1}{{N}_{t}} {\sum }_{i = 1}^{{N}_{t}} exp ( - ϵ {\sum }_{k = 1}^{i - 1} {ℒ}_{r} ( {t}_{k} , θ ) ) {ℒ}_{r} ( {t}_{k} , θ ) \qquad ( 3.3 )$$

Notice that wᵢ is inversely exponentially proportional to the magnitude of the cumulative residual loss from the previous time steps. As a consequence, Lr(tᵢ,θ) will not be minimized unless all previous residuals { [symbol] (tₖ,θ)}ₖ₌₁ⁱ⁻¹ decrease to some small value such that wᵢ is large enough.

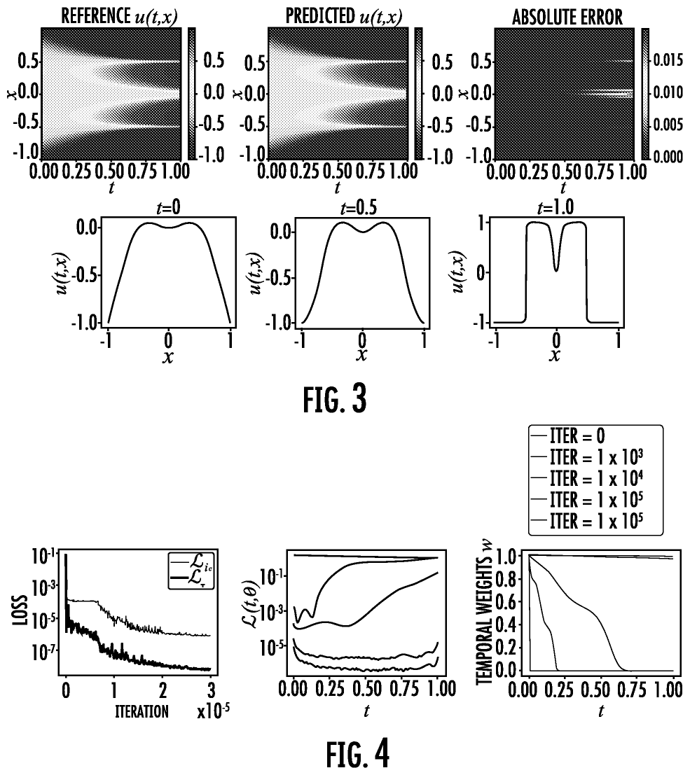

We now employ this simple modification and revisit the Allen-Cahn case study discussed before. We proceed by training the same network by minimizing the loss of equation 2.4 using the weighted residual loss of equation 3.3 with ϵ=100, for 3×10⁵ iterations of gradient descent under exactly the same hyper-parameter settings. The results of this experiment are summarized in FIG. 3. One can see that the predicted solution achieves an excellent agreement with the ground truth, yielding an approximation error of 1.43e-03 measured in the relative L² norm. The left panel of FIG. 4 presents the convergence of the different loss function components, which is evidently much better than the one presented in FIG. 2. Here we note that no other modifications between the two cases exist, besides the use of the proposed weighted residual loss of equation 3.3.

In fact, if in conjunction with the weighted residual loss we also employ a more powerful architecture for this example, such as the modified MLP [12], we can achieve an even more accurate result with a resulting relative L² error of 1.39e-04.

Finally, in Table 1 we provide the accuracy reported for this problem by existing approaches in the literature [14, 16, 25]. It is evident that the proposed methodology outperforms the best reported result of competing approaches by a factor of ˜10-100×. This is a strong indication of the significance and necessity of respecting causality in training PINNs.

TABLE 1
Allen-Cahn equation: Relative L² errors
obtained by different approaches.

| | Relative |
|---|---|
| Method | L² error |
| Original formulation of Raissi et al. [11] | 4.98e−01 |
| Adaptive time sampling [16] | 2.33e−02 |
| Self-attention [14] | 2.10e−02 |
| Time marching [25] | 1.68e−02 |
| Causal training (MLP) | 1.43e−03 |
| Causal training (modified MLP) | 1.39e 04 |

A stopping criterion for assessing training convergence: To understand the effect of the residual weights {wᵢ}, we present the temporal residual loss and weights at different iterations of gradient descent in the middle and right panel of FIG. 4. We observe that the initial temporal weights are all zero except for t=0, implying that only Lr(t₀,θ) will be minimized at the beginning of training. Throughout the rest of the training, more temporal weights are activated, and eventually, all of them converge to 1 as the PDE residual loss is properly minimized. This last observation suggests that monitoring the magnitude of the residual weights {wᵢ} can provide an effective stopping criterion for assessing the convergence of a PINNs model during training. Specifically, one can choose to terminate training of minᵢ wᵢ>δ, for some chosen threshold parameter δ∈(0,1). This stopping criterion not only helps to train a PINNs model faster, but it actually yields trained models with superior predictive accuracy.

Sensitivity on the causality parameter E: Here we must note that the results obtained using the proposed weighted residual loss do exhibit some sensitivity to the causality parameter e in equation 3.2. Choosing a very small ϵ can prevent the network from effectively minimizing the latter temporal residuals. On the other hand, choosing a large ϵ value can result in a more difficult optimization problem, because the temporal residuals at earlier times have to decrease to a very small value in order to activate the latter temporal weights. This may be hard to achieve in some cases due to limited network capacity in minimizing the target residuals. In order to avoid tedious hyper-parameter tuning, we employ an annealing strategy for adjusting e using an increasing sequence of values {εᵢ}=1, which gradually increases the strength with which the PDE residual constraint is enforced. We empirically observe that this choice yields the best results in practice.

Fitting the initial data: In the spirit of respecting causality, one may recognize that all temporal residuals should be minimized only if the network can first accurately fit the initial data. Therefore, we may treat the initial loss Lic as a special temporal residual at t=0 and incorporate it into the weighted residual loss of equation 3.1 in the same manner.

Causal training for PINNs: Based on the above remarks, Algorithm 1 presents a general causal training algorithm for PINNs. Specifically, it summarizes the proposed re-formulation of the residual and initial conditions loss, the annealing scheme for the e parameter, and the stopping criterion for terminating the training upon convergence of the wᵢ weights.

### Algorithm 1: Causal Training for Physics-Informed Neural Networks

Consider a physics-informed neural network u_{θ}(t,x) imposed the exact boundary conditions, and the corresponding weighted loss function

$${ℒ}_{r} ( θ ) = \frac{1}{{N}_{t}} {\sum }_{i = 0}^{{N}_{t}} {w}_{i} {ℒ}_{r} ( {t}_{i} , θ ) \qquad ( 3.4 )$$

where L(t₀,θ)=λ_{ic}Lic(θ) and for 1≤i≤Nₜ, L(tᵢ,θ) is defined in Equation 2.13. All wᵢ are initialized by 1. Then use S steps of a gradient descent algorithm to update the parameters θ as:

| for ϵ = ϵ₁, . . . , ϵₖ do | | | | |
|---|---|---|---|---|
| \| | for n = 1, . . . , S do | | | |
| \| | \| | | (a) Compute and update the temporal weights by | |
| \| | \| | | ${w}_{i} = exp ( - ϵ {\sum }_{k = 1}^{i - 1} ℒ ( {t}_{k} , θ ) ) , for i = 2 , 3 , … , {N}_{t} . \qquad \\$ | (3.5) |
| \| | \| | | Here ϵ > 0 is a user-defined hyper-parameter that determines the “slope” of temporal weights. | |
| \| | \| | | (b) Update the parameters θ via gradient descent | |
| \| | \| | | θₙ₊₁ = θₙ − η∇_{θ} [symbol] (θₙ) | (3.6) |
| \| | \| | if minᵢ wᵢ > δ then | | |
| \| | \| | \| | break | |

| | | |
|---|---|---|
| \| | \| | end |

| \| | end |
|---|---|
| end | |
| | The recommended hyper-parameters are λ_{ic} = 10³, δ = 0.99 and (ϵᵢ}ᵢ₌₁^{k} = [10⁻², 10⁻¹, 10⁰, 10¹, 10²]. |

Accompanying Algorithm 1, here we present a few additional remarks worth discussing.
1. Although in this work we have limited our attention to PDEs with periodic boundary conditions that can be enforced in an exact manner, the proposed causal training algorithm can be adapted to also incorporate boundary constraints using a similar treatment to the initial conditions loss.
2. Note that the temporal weights {wᵢ}ᵢ₌₀^{N}^{ₜ} are a function of the trainable parameters θ. We use lax.stop_gradient in our JAX [35] implementation to prevent gradient back-propagation through the computation of wᵢ.
3. The computational cost of the proposed algorithm is negligible compared to conventional PINNs formulations since the weights wᵢ are computed by directly evaluating the PINNs loss functions, whose values are already stored in the computational graph during training.
4. The proposed algorithm is not limited to fixed mesh points for evaluating the PINNs loss terms, and the collocation points can be randomly sampled at each iteration of gradient descent. The only requirement is that the sampled temporal points{tᵢ}ᵢ₌₁^{N}^{ₜ} should form a non-decreasing sequence in temporal domain so that temporal causality can be respected.

Here we should also mention that Algorithm 1 is general and can be employed within any existing physics-informed machine learning pipeline, including physics-informed neural networks [11, 36, 30, 19, 21, 37], physicsinformed deep operator networks [38, 39, 40], and physics-informed neural operators [41].

Connection to existing approaches: It is worth pointing out that the proposed residual weighting strategy bears some similarity to the adaptive time sampling of Wight et al. [16], since the effect of the weights wᵢ can be viewed as equivalent to changing the sampling density of collocation points. However, the method of Wight et al. has two main disadvantages in practice: a) the sampling density has to be manually designed for different problems and training iterations, and b) an accurate approximation of the designed sampling density requires a large volume of collocation points, leading to a large computational cost. Besides, we remark that our method shares the same motivation with “time-marching” or “curriculum training” strategies [16, 24, 42, 43], in the sense of respecting temporal causality by learning the solution sequentially within separate time-windows. In fact, our causal training strategy should not be viewed as a replacement of time-marching approaches, but instead as a crucial enhancement to those, given the fact that violation of causality may still occur within each time window of a time-marching algorithm.

### Practical Considerations

High-order accuracy becomes a necessity for PINNs in order to tackle problems exhibiting sensitivity on initial data and strong spatio-temporal correlations (e.g. chaotic systems). Although PINNs are known for being incapable to achieve high-order accuracy in general, in this section we highlight a few extensions that can further enhance their performance in more challenging settings. Although these features are not deemed crucial for the successful application of Algorithm 1, we have empirically observed that, for the problems considered in this work, they can lead to further enhancements in terms of accuracy and computational efficiency.

Modified multi-layer perceptions: In [12] Wang et al. put forth a novel architecture that was demonstrated to outperform conventional MLPs across a variety of PINNs benchmarks. Here, we will refer to this architecture as “modified MLP”. The forward pass of a L-layer modified MLP is defined as follows

$$U = σ ( {XW}_{1} + {b}_{1} ) , V = σ ( {XW}_{2} + {b}_{2} ) \qquad ( 4.1 )$$

$${H}^{( 1 )} = σ ( {XW}^{( l )} + {b}^{( l )} ) \qquad ( 4.2 )$$

$${Z}^{( l )} = σ ( {H}^{( k )} {W}^{( l )} + {b}^{( l )} ) , l = 1 , … , L - 1 \qquad ( 4.3 )$$

$${H}^{( l + 1 )} = ( 1 - {Z}^{( l )} ) ⊙ U + {Z}^{( l )} ⊙ V , l = 1 , … , L - 1 \qquad ( 4.4 )$$

$${u}_{θ} ( X ) = {H}^{( L )} {W}^{( L )} + {b}^{( L )} , \qquad ( 4.5 )$$

where σ denotes a nonlinear activation function, ⊙ denotes a pointwise multiplication, and X denotes an batch of input coordinates. All trainable parameters are given by

$$θ = \{ {W}_{1} , {b}_{1} , {W}_{2} , {b}_{1} , {( {W}^{( l )} , {b}^{( l )} )}_{l = 1}^{L} \} \qquad ( 4.6 )$$

At first glance, this architecture seems to appear a bit complicated. However, notice that it is almost the same as a standard MLP network, with the addition of two encoders and a minor modification in the forward pass. Specifically, the inputs X are embedded into a feature space via two encoders U,V, respectively, and merged in each hidden layer of a standard MLP using a point-wise multiplication. Based on our prior experience, the modified MLP architecture is shown to be more powerful than standard MLPs in terms of minimizing the PDE residuals and capturing sharp gradients [12, 9, 38, 39].

Exact periodic boundary conditions: Recent work by Dong et al. showed how one can strictly impose periodic boundary conditions in PINNs as hard-constraints. We have empirically observed that this trick can simplify the training of PINNs and introduce some savings in terms of computational cost. To illustrate the main idea, let us consider enforcing periodic boundary conditions with period P in a one-dimensional setting. To this end, we would like to make sure that a neural network returns periodic predictions as

$${u}^{( l )} ( a ) = {u}^{( l )} ( a + P ) , I = 0 , 1 , 2 , … \qquad ( 4.7 )$$

To enforce this constraint as part of the architecture itself, we construct a Fourier feature embedding of the form

$$( 4.8 )$$

$$v ( x ) = ( 1 , cos ( ω x ) , sin ( ω x ) , cos ( 2 ω x ) , sin ( 2 ω x ) , … , cos ( m ω x ) , sin ( m ω x ) )$$

$$with ω = \frac{2 π}{L} ,$$

and some non-negative integer m. Then, for any network representation u_{θ}, it can be proved that any u_{θ}(v(x)) exactly satisfies the periodic constraint of equation 4.7 (see for a proof).

The same idea can be extended to higher-dimensional domains. For instance, let (x,y) denote the coordinates of a point in two dimensions, and suppose that u(x,y) is a smooth periodic function to be approximated in a periodic cell [a, a+Pₓ]×[b,b+P_{y}], satisfying the following constraints

$$\begin{matrix}\frac{{\partial }^{l}}{\partial {x}^{l}} u ( a , y ) = \frac{{\partial }^{l}}{\partial {x}^{l}} u ( a + {P}_{x} , y ) , & y ∈\end{matrix} [ b , b + {P}_{y ] ,} \qquad ( 4.9 )$$

$$\begin{matrix}\frac{{\partial }^{l}}{\partial {y}^{l}} u ( x , a ) = \frac{{\partial }^{l}}{\partial {y}^{l}} u ( x , b + {P}_{y} ) , & x ∈ [ a , a + {P}_{x ] ,}\end{matrix} \qquad ( 4.1 )$$

for l=0, 1, 2, . . . , where Pₓ and P_{y} are the periods in the x and y directions, respectively. Similar to the onedimensional setting, these constraints can be implicitly encoded in a neural network by constructing a two-dimensional Fourier features embedding as

$$( 4.11 )$$

$$v ( x , y ) = [ \begin{matrix}cos ( {ω}_{x} x ) cos ( {ω}_{y} y ) , … , cos ( n {ω}_{x} x ) cos ( m {ω}_{y} y ) \\ cos ( {ω}_{x} x ) sin ( {ω}_{y} y ) , … , cos ( n {ω}_{x} x ) sin ( m {ω}_{y} y ) \\ sin ( {ω}_{x} x ) cos ( {ω}_{y} y ) , … , sin ( n {ω}_{x} x ) cos ( m {ω}_{y} y ) \\ sin ( {ω}_{x} x ) sin ( {ω}_{y} y ) , … , sin ( n {ω}_{x} x ) sin ( m {ω}_{y} y ) ,\end{matrix} ]$$

$$with {w}_{x} = \frac{2 π}{{P}_{x}} , {w}_{y} = \frac{2 π}{{P}_{y}}$$

and m,n being some non-negative integers. Following [44], any network representation u_{θ}(v(x,y)) is guaranteed to be periodic in the x, y directions.

For time-dependent problems, we simply concatenate the time coordinates t with the constructed Fourier features embedding, i.e., u_{θ}([t,v(x)]), or u_{θ}([t,v(x,y)]). Although in this work we will only consider periodic problems, other types of boundary conditions, including Dirichlet, Neumann, Robin, etc., can also be enforced in a “hard” manner, see [45, 46] for more details.

Taylor-mode automatic differentiation for high-order derivatives:

Conventional forward- or reverse-mode automatic differentiation is known to incur a cost that scales exponentially—both in terms of memory and compute—with the order of differentiation. This can quickly introduce a bottleneck in cases where derivatives of order higher than two are required (see e.g. the Kuramoto-Sivashinsky benchmark). To address this drawback, here
we employ Taylor-mode automatic differentiation [31] in order to accelerate the computation of high-order derivatives. This is accomplished by leveraging a truncated Taylor polynomial approximation that allows for efficient computation of high-order derivatives of function compositions via the Faà di Bruno formula

$$( 4.12 )$$

$$\frac{{\partial }^{n}}{\partial {x}_{1} … \partial {x}_{n}} f ( g ( x ) ) = {\sum }_{σ ∈ {τ}_{\{ 1 , … n \}}} {f}^{( \vert σ \vert )} ( g ( x ) ) {\prod }_{b ∈ σ} \frac{{\partial }^{\vert b \vert}}{{\prod }_{j ∈ b} {\partial }_{{x}_{j}}} g ( x ) ,$$

where π{1, . . . , n} is the set of all partitions of the set {1, . . . , n}. It has been shown that Taylor-mode automatic differentiation enjoys much better scaling that conventional forward- or reverse-mode automatic differentiation, with its benefits becoming increasingly more dramatic as the order of differentiation is increased [47]. In terms of implementation, we leverage the jax.jet primitive accompanying the work of Bettencourt et al. [47, 35].

Parallel Training: Graphics processing units (GPUs) are the prevailing hardware choice for training PINNs, however these devices are often bound by their memory capacity. For more complex simulation scenarios (e.g. the Navier-Stokes benchmark) we have empirically observed that using larger batch sizes during training leads to enhanced convergence and predictive accuracy. However, a desirable batch size might exceed the available memory that a single GPU can offer, therefore motivating the use of data-parallelism across multiple GPU devices. In order to facilitate this, we utilize synchronous data-parallelism across multiple GPUs, with each GPU storing an identical copy of all trainable parameters. In this paradigm, a batch of training data is split into sub-batches, one for each device. Specifically, batches of spatial and temporal points used to evaluate the training loss are generated randomly and independently on each available GPU, and gradients of the training loss are then aggregated across all devices with a collective reduce-mean operation. As such, each device can then update its own local copy of all trainable model parameters at each gradient descent iteration the using global gradient signal that is broadcasted across all devices. In our implementation, this is efficiently performed leveraging the jax.pmap primitive in JAX [35], allowing us to seamlessly scale our code to an arbitrary number of GPUs. The parallel performance of our implementation will be assessed via strong and weak scaling studies.

### Results

Our goal in this section is to demonstrate the effectiveness of the proposed causal training algorithm by providing state-of-the-art numerical results for various types of differential equations exhibiting chaotic behavior, where existing PINNs formulations are destined for failure. Specifically, we will consider the forward simulation of the chaotic Lorenz system, the Kuramoto-Sivashinsky equation, and a two-dimensional simulation of decaying turbulence governed by the incompressible Navier-Stokes equations. Although these benchmarks can all be easily tackled using conventional numerical methods, they have remained elusive to PINNs since their initial conception [48, 28], and all the variants that followed the reincarnation of this framework by Raissi et al. [29].

Throughout all benchmarks, we will employ the modified MLP architecture equipped with hyperbolic tangent activation functions (Tan h) and initialized using the Glorot normal scheme [49]. We will enforce periodic boundary conditions as hard constraints by constructing appropriate Fourier features embedding of the input. All networks are trained via stochastic gradient descent using the Adam optimizer with default settings and an exponential learning rate decay with a decay-rate of 0.9 every 5,000 training iterations. As suggested by [16, 24, 25], we will also employ time-marching to reduce optimization difficulties. Specifically, we will split up the temporal domain of interest [0, T] into sub-domains [0,Δt], [Δt,2Δt], . . . [T−Δt, T], and train networks to learn the solution in each sub-domain, where the initial condition is obtained from the prediction of the previously trained network. At the end of training, the resulting PINN model can produce predictions for the target solution at any continuous query location in the global spatio-temporal domain.

### Lorentz System

As our first example, we consider the chaotic Lorenz system. It is well known that this system exhibits strong sensitivity to its initial conditions, which can trigger divergent trajectories in finite time if the numerical predictions sought are not sufficiently accurate. The system is described by the following ordinary differential equations

$$\frac{dx}{dt} = σ ( y - x ) , \qquad ( 5.1 )$$

$$\frac{dy}{dt} = x ( ρ - z ) - y , \qquad ( 5.2 )$$

$$\frac{dz}{dt} = xy - β z . \qquad ( 5.3 )$$

These equations arise in studies of convection and instability in planetary atmospheric convection, where x, y, and z denote variables proportional to convective intensity, horizontal, and vertical temperature differences [ ]. Parameters ρ, σ and β denote the Prandtl number, Rayleigh number, and a geometric factor, respectively. The Lorenz system is well-known to be chaotic for certain parameter values and initial conditions. Here, we consider a classical setting with σ=3, ρ=28, and β=8/3. Our goal is to construct a PINNs model for learning the ODE solution up to time T=20, starting from an initial condition [x(0), y(0), z(0)]=[1,1,1] that does not lie on the system's attractor.

FIG. 5 shows the predicted trajectory against the reference trajectory obtained via a classical numerical solver, where an excellent agreement can be observed with a relative L² error 1.139e—02, 1.656e—02, 7.038e—03 for the x,y,z components, respectively. We can see that the stopping criterion min; wᵢwᵢ>δ is satisfied for the training of each time window. It is worth pointing out that the proposed stopping criterion will not only benefit the predictive accuracy, but also save lots of computational costs. To verify this, we train the network by removing the stopping criterion and training for a fixed number of iterations for each time window under exactly the same hyper-parameter setting. Interestingly, the training losses can achieve slightly lower values than the ones using the stopping criterion. However, the model predictions are less accurate, and some discrepancies can be clearly observed. Although the reason behind this behavior still remains unclear, it appears that training the model for more iterations after the proposed stopping criterion has been met, seems to give rise to overfitting.

### Kuramoto-Sivashinsky Equation

The next example aims to illustrate the effectiveness of our method in tackling spatio-temporal chaotic systems. To this end, we consider onedimensional Kuramoto-Sivashinsky equation, which has been independently derived in the context of reaction-diffusion systems and flame front propagation [51]. The Kuramoto-Sivashinsky equation exhibits a wealth of spatially and temporally nontrivial dynamical behavior including chaos, and has served as a model example in efforts to understand and predict the complex dynamical behavior associated with a variety of physical systems. The equation takes the form

$${u}_{t} + α {uu}_{x} + β {u}_{xx} + {yu}_{xxxx} = 0 , \qquad ( 5.4 )$$

subject to periodic boundary conditions and an initial condition

$$u ( 0 , x ) = {u}_{0} ( x ) . \qquad ( 5.5 )$$

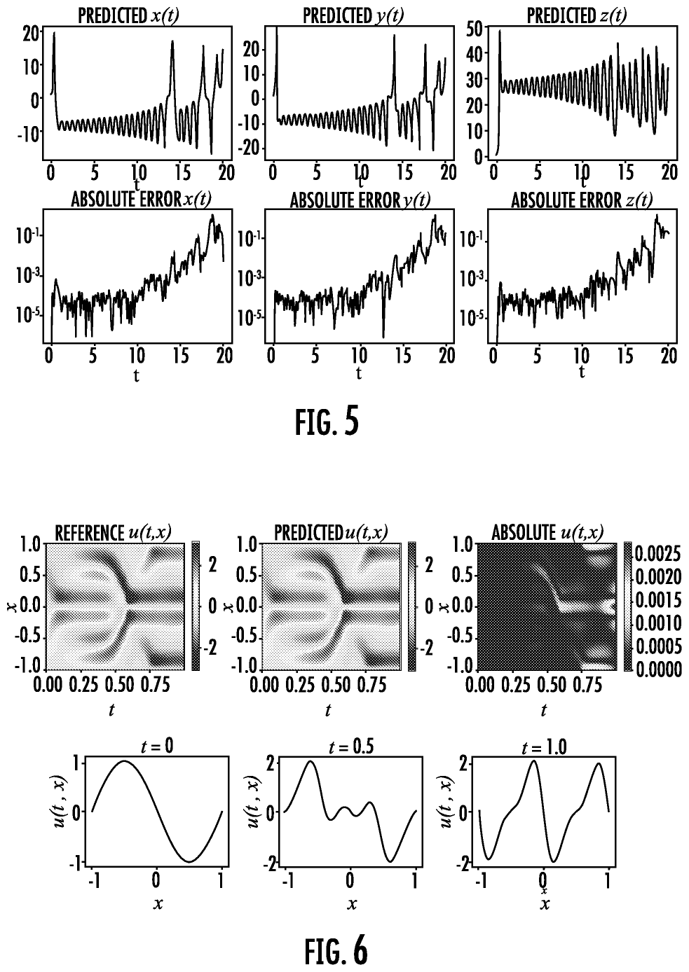

Case I (regular): We start with a relatively simple scenario by setting α=5, β=0.5, γ=0.005, and a spatial domain [−1,1]. The initial condition is given by u₀(x)=−sin(πx). Our goal is to lean the associated solution up to time T=1. A detailed visual assessment of the predicted solution is presented in FIG. 6. In particular, we present a comparison between the reference and the predicted solutions at different time instants t=0,0.5,1.0. It can be observed that the PINNs prediction achieves an excellent agreement with the reference solutions, yielding an error of 3.49e—04 measured in the relative L² norm. This is further illustrated by the temporal relative L² error shown in the left panel of FIG. 8. Particularly, one may note that the error increases drastically by one order of magnitude for t∈[0.4,0.6] where the solution happens to experience a fast transition. This behavior is consistent with the larger loss values and the larger number of training iterations required before the stopping criterion is met.

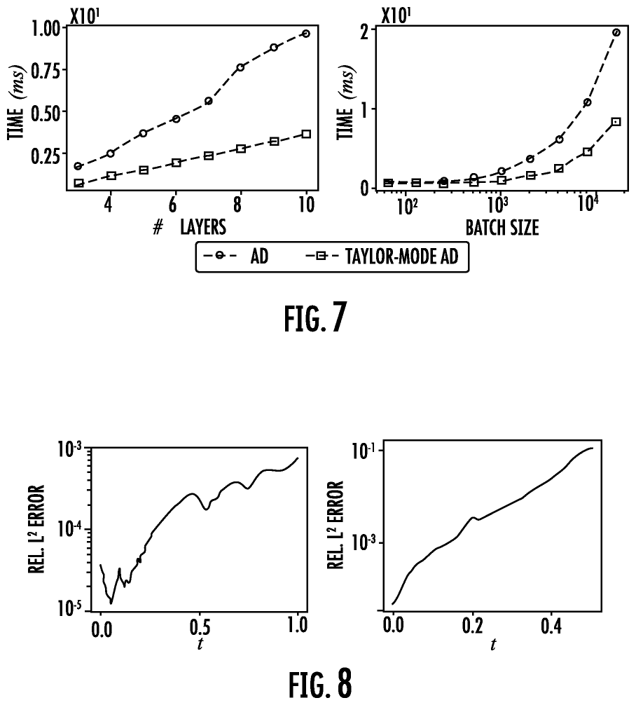

To highlight the computational efficiency of Taylor-mode automatic differentiation (Taylor-mode AD), here we provide a comparison in terms of computational cost against conventional reverse-mode automatic differentiation (AD) [31]. Specifically, we consider PINN models with a different number of layers and batch sizes. As shown in FIG. 7, Taylor-mode AD provides a significant advantage in terms of computational efficiency, allowing us to accommodate larger architectures and batch sizes. As a consequence, for the same architecture and batch size, we have consistently observed a speed-up of 3-5× in the total training time required for Taylor-mode AD versus conventional AD.

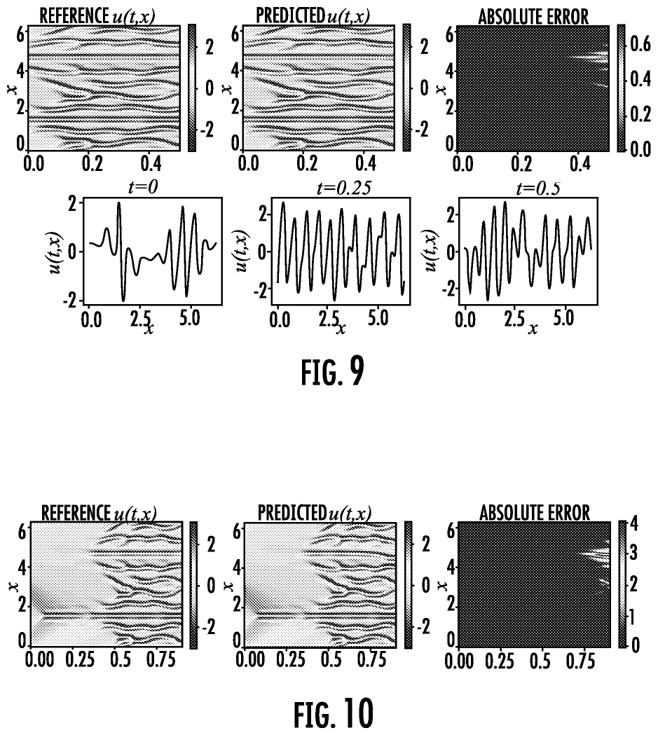

Case II (chaotic): We proceed by solving a more challenging case exhibiting chaotic behavior, which remains stubbornly unsolved using existing PINNs formulations [52]. Specifically, we set α=100/16, β=100/16², γ=100/16⁴, for a fixed spatial domain in [0,2π]. Starting from an initial condition in the chaotic regime, we use PINNs to solve Kuramoto-Sivashinsky equation up to time T=0.5. The results are summarized in FIG. 9, from which one can see that the predicted solution is in good agreement with the reference solution obtained via classical spectral methods. The resulting relative L² error over the entire spatio-temporal domain is 2.46e-02, which is visualized in the right panel of FIG. 8. These results highly suggest that the proposed causal training algorithm enables the PINN model to capture the intricate chaotic behavior of this system.

From a critical standpoint, here we should also mention that difficulties can still arise in simulating the long-time behavior of chaotic systems. FIG. 10 summarizes our results starting with a simple initial state u₀(x)=cos(x)(1+sin(x)), and simulating the dynamics up to time T=0.9. One can observe that the predicted solution accurately captures the transition to chaos at around t=0.4, while eventually loses accuracy after t=0.8 due to the chaotic nature of the problem and the inevitable numerical error accumulation of PINNs, leading to a relative L² error above 10% for the final state. This highlights the crucial need for further enhancing the accuracy of PINN approximations in order to retain effectiveness in such complex regimes. Long-time integration in general, has been one PINNs' major drawbacks, and in future work we plan to address this via operator learning techniques as described in [39].

### Navier-Stokes Equation

To further emphasize the effectiveness of the proposed causal training algorithm for solving chaotic dynamical systems, in the last example, we consider a classical two-dimensional decaying turbulence example in a square domain with periodic boundary conditions. This problem can be modeled via the incompressible Navier-Stokes equations using expressed in the velocity-vorticity formulation

$$\begin{matrix}{w}_{t} + u \cdot ∇ w = \frac{1}{Re} Δ w , & in [ 0 , T ] \times Ω\end{matrix} , \qquad ( 5.6 )$$

$$\begin{matrix}∇ \cdot u = 0 & in [ 0 , T ] \times Ω\end{matrix} , \qquad ( 5.7 )$$

$$\begin{matrix}w ( 0 , x , y ) = {w}_{0} ( x , y ) , & in Ω\end{matrix} , \qquad ( 5.8 )$$

where u=(u,v) denotes the flow velocity field, w=∇×u denotes the vorticity, and Re is the Reynolds number. In addition, we set (= [0,2π]² and Re=100. Our goal is to use PINNs to simulate the flow up to T=1.

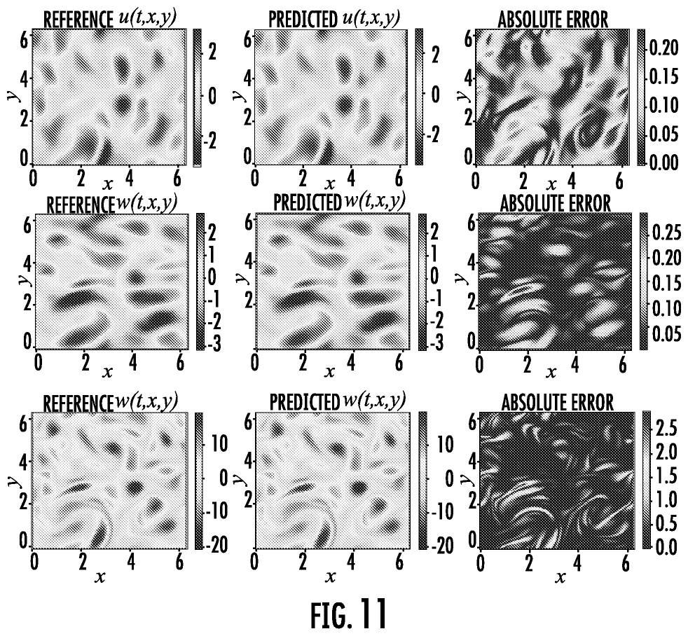

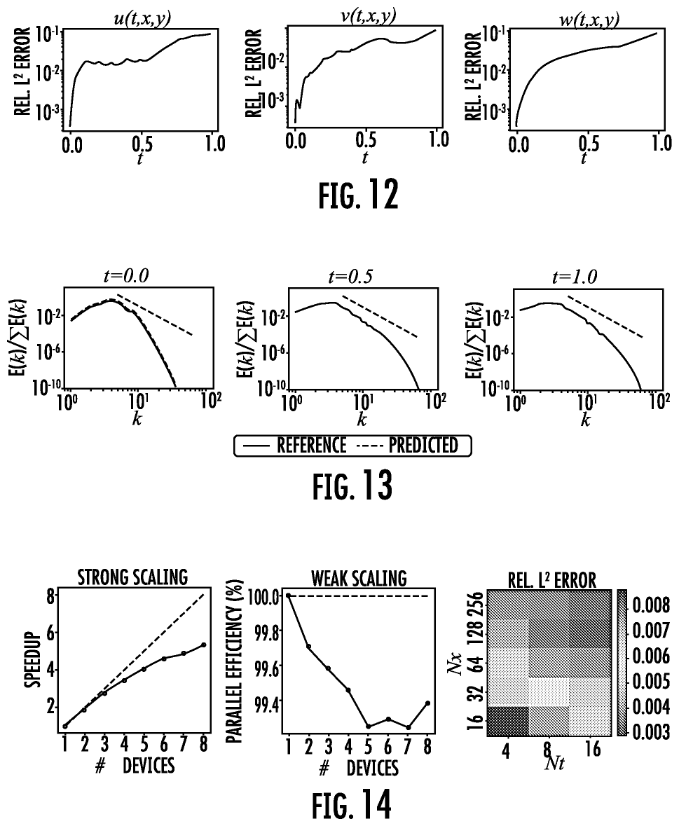

FIG. 11 presents the predicted velocity and vorticity field at T=1. We can see that all latent variables of interest are in good agreement with their corresponding reference solution, yielding an error of 3.90e−02,2.61e−02,3.53e−02 for u,v,w, respectively, over the entire spatiotemporal domain. This observation is further illustrated by the resulting errors reported in FIG. 12 and the computed energy spectrum in FIG. 13. These results highlight the remarkable effectiveness of the proposed causal training algorithm, successfully enabling the PINNs model to capture such complicated turbulent flow without any training data.

For this benchmark, we also report the performance of our parallel JAX implementation on a compute node equipped with 8 NVIDIA Ampere A6000 GPUs. We use an effective batch-size of 42,000 spatio-temporal points sampled in each training iteration on each GPU with a network consisting of 6 layers with 300 neurons per layer. FIG. 14 presents the scaling results obtained. To conduct a strong scaling study, we keep the problem size fixed and split the batch across several GPUs. As expected, we notice a speed-up, but the benefits deteriorate as number of GPUs is increased beyond 4. We attribute this behavior to the fact that, for a fixed problem size, the compute load assigned to each GPU decreases as the number of devices is increased, leading to an under-utilization of each device. We have also performed a weak scaling study in which the number of points sampled per GPU is fixed. Under this setting, we report excellent parallel efficiency that remains above 99% as the number of GPUs is increased. While we have only considered data-parallelism in this study, we may be able to obtain further speed-ups by considering a combination of data- and function-parallelism techniques in future studies. FIG. 14 also reports the effect of batch-size of training on the resulting L² accuracy for the first time-window (t∈[0,0.1]). In general, we notice that an increase in batch-size results in higher accuracy of the network. This motivates the use of larger batch-sizes through data-parallelism as a mechanisms for enhancing the accuracy of PINNs in more challenging problems.

### Discussion

Physical systems possess an inherent causal structure that explains the fundamental relationship between causes and effects governing their dynamic evolution. In this work, we show that physics-informed neural networks are prone to violating that structure when trained to infer the solution of time-dependent PDEs. Specifically, by studying the limiting neural tangent kernel of PINNs we reveal an implicit bias indicating a preference of PINNs to first minimize PDE residuals at later times, before even fitting the initial data. We argue that this fundamental drawback is one to of the key reasons why PINNs can fail in practice. To resolve this shortcoming, we propose a novel causal training algorithm that can restore physical causality during the training of a PINNs model by appropriately re-weighting the PDE residual loss at each iteration of gradient descent. Interestingly, this also leads to a simple stopping criterion for effectively assessing the convergence of the total training loss. We demonstrate that this simple modification alone is sufficient to achieve 10-100× improvements in accuracy compared to competing approaches, opening the path to tackling challenging problems that were not accessible to PINNs before, such as the chaotic Lorenz and Kuramoto-Sivashinsky equations, and the incompressible Navier-Stokes equations in the turbulent regime.

Given the rising prominence of PINNs across academic and industrial use cases, we consider this as a hallmark contribution that sets a new standard for what such models are capable for. We anticipate that findings of this work will create new opportunities for the application of PINNs to increasingly more complex scenarios across diverse domains including fluid mechanics, electromagnetics, quantum mechanics, and elasticity. However, despite the encouraging results reported here, there is a still gap between the current progress in PINNs research and real-world applications. We have to admit that viewing PINNs as a forward PDE solver is significantly more time-consuming than the traditional numerical solvers. Therefore, the future research should focus on how to accelerate PINNs training and scale it to more complex scenarios. To this end, distributed and parallel implementations can be of great help [54, 21]. Another aspect with great room for improvement is related to architecture design. Even though effective modifications such as the modified MLP can introduce noticeable gains in terms of accuracy, a niche architecture similar to what convolutional networks have been for vision or Transformers for language processing, is yet to be discovered for solving PDEs. To this regard we must recognize that training a PINN model is fundamentally different from conventional supervised learning tasks, requiring us to design more effective architectures for minimizing the PDE residuals in a self-supervised manner.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

### REFERENCES

[1] Maziar Raissi, Alireza Yazdani, and George Em Karniadakis. Hidden fluid mechanics: Learning velocity and pressure fields from flow visualizations. Science, 367(6481): 1026-1030, 2020.
[2] Abhilash Mathews, Manaure Francisquez, Jerry W Hughes, David R Hatch, Ben Zhu, and Barrett N Rogers. Uncovering turbulent plasma dynamics via deep learning from partial observations. Physical Review E, 104(2): 025205, 2021.
[3] Georgios Kissas, Yibo Yang, Eileen Hwuang, Walter R Witschey, John A Detre, and Paris Perdikaris. Machine learning in cardiovascular flows modeling: Predicting arterial blood pressure from non-invasive 4D flow MRI data using physics-informed neural networks. Computer Methods in Applied Mechanics and Engineering, 358:112623, 2020.
[4] Alireza Yazdani, Lu Lu, Maziar Raissi, and George Em Karniadakis. Systems biology informed deep learning for inferring parameters and hidden dynamics. PLOS computational biology, 16(11): e1007575, 2020.
[5] Sifan Wang and Paris Perdikaris. Deep learning of free boundary and Stefan problems. Journal of Computational Physics, 428:109914, 2021.
[6] Khemraj Shukla, Patricio Clark Di Leoni, James Blackshire, Daniel Sparkman, and George Em Karniadakis. Physics-informed neural network for ultrasound nondestructive quantification of surface breaking cracks. Journal of Nondestructive Evaluation, 39(3): 1-20, 2020.
[7] Yuyao Chen, Lu Lu, George Em Karniadakis, and Luca Dal Negro. Physics-informed neural networks for inverse problems in nano-optics and metamaterials. Optics express, 28(8): 11618-11633, 2020.
[8] Francisco Sahli Costabal, Yibo Yang, Paris Perdikaris, Daniel E Hurtado, and Ellen Kuhl. Physics-informed neural networks for cardiac activation mapping. Frontiers in Physics, 8:42, 2020.
[9] Sifan Wang, Hanwen Wang, and Paris Perdikaris. On the eigenvector bias of fourier feature networks: From regression to solving multi-scale PDEs with physics-informed neural networks. Computer Methods in Applied Mechanics and Engineering, 384:113938, 2021.
[10] George Em Karniadakis, Ioannis G Kevrekidis, Lu Lu, Paris Perdikaris, Sifan Wang, and Liu Yang. Physicsinformed machine learning. Nature Reviews Physics, pages 1-19, 2021.
[11] Maziar Raissi, Paris Perdikaris, and George E Karniadakis. Physics-informed neural networks: A deep learning framework for solving forward and inverse problems involving nonlinear partial differential equations. Journal of Computational Physics, 378:686-707, 2019.
[12] Sifan Wang, Yujun Teng, and Paris Perdikaris. Understanding and mitigating gradient flow pathologies in physics-informed neural networks. SIAM Journal on Scientific Computing, 43(5): A3055-A3081, 2021.
[13] Sifan Wang, Xinling Yu, and Paris Perdikaris. When and why PINNs fail to train: A neural tangent kernel perspective. Journal of Computational Physics, 449:110768, 2022.
[14] Levi McClenny and Ulisses Braga-Neto. Self-adaptive physicsinformed neural networks using a soft attention mechanism. arXiv preprint arXiv:2009.04544, 2020.
[15] Suryanarayana Maddu, Dominik Sturm, Christian L Müller, and Ivo F Sbalzarini. Inverse dirichlet weighting enables reliable training of physics informed neural networks. Machine Learning: Science and Technology, 2021.
[16] Colby L Wight and Jia Zhao. Solving Allen-Cahn and CahnHilliard equations using the adaptive physics informed neural networks. arXiv preprint arXiv:2007.04542, 2020.
[17] Mohammad Amin Nabian, Rini Jasmine Gladstone, and Hadi Meidani. Efficient training of physics-informed neural networks via importance sampling. Computer-Aided Civil and Infrastructure Engineering, 2021.
[18] Jie Bu and Anuj Karpatne. Quadratic residual networks: A new class of neural networks for solving forward and inverse problems in physics involving PDEs. In Proceedings of the 2021 SIAM International Conference on Data Mining (SDM), pages 675-683. SIAM, 2021.
[19] Ameya D Jagtap, Yeonjong Shin, Kenji Kawaguchi, and George Em Karniadakis. Deep kronecker neural networks: A general framework for neural networks with adaptive activation functions. Neurocomputing, 468:165-180, 2022.
[20] Senwei Liang, Liyao Lyu, Chunmei Wang, and Haizhao Yang. Reproducing activation function for deep learning. arXiv preprint arXiv:2101.04844, 2021.
[21] Ameya D Jagtap and George Em Karniadakis. Extended physics-informed neural networks (XPINNs): A generalized space-time domain decomposition based deep learning framework for nonlinear partial differential equations. Communications in Computational Physics, 28(5): 2002-2041, 2020.
[22] Ben Moseley, Andrew Markham, and Tarje Nissen-Meyer. Finite basis physics-informed neural networks (fbpinns):
   a scalable domain decomposition approach for solving differential equations. arXiv preprint arXiv:2107.07871, 2021.
[23] Ameya D Jagtap, Kenji Kawaguchi, and George Em Karniadakis. Adaptive activation functions accelerate convergence in deep and physics-informed neural networks. Journal of Computational Physics, 404:109136, 2020.
[24] Aditi S Krishnapriyan, Amir Gholami, Shandian Zhe, Robert M Kirby, and Michael W Mahoney. Characterizing possible failure modes in physics-informed neural networks. arXiv preprint arXiv:2109.01050, 2021.
[25] Revanth Mattey and Susanta Ghosh. A novel sequential method to train physics informed neural networks for allen cahn and cahn hilliard equations. Computer Methods in Applied Mechanics and Engineering, 390:114474, 2022.
[26] Walter A Strauss. Partial differential equations: An introduction. John Wiley & Sons, 2007.
[27] L. C. Evans and American Mathematical Society. Partial Differential Equations. Graduate studies in mathematics. American Mathematical Society, 1998.
[28] Isaac E Lagaris, Aristidis Likas, and Dimitrios I Fotiadis. Artificial neural networks for solving ordinary and partial differential equations. IEEE transactions on neural networks, 9(5): 987-1000, 1998.
[29] Maziar Raissi, Hessam Babaee, and Peyman Givi. Deep learning of turbulent scalar mixing. Physical Review Fluids, 4(12): 124501, 2019.
[30] Ehsan Kharazmi, Zhongqiang Zhang, and George Em Karniadakis. Variational physics-informed neural networks for solving partial differential equations. arXiv preprint arXiv:1912.00873, 2019.
[31] Andreas Griewank and Andrea Walther. Evaluating derivatives: principles and techniques of algorithmic differentiation. SIAM, 2008.
[32] Diederik P Kingma and Jimmy Ba. Adam: A method for stochastic optimization. arXiv preprint arXiv:1412.6980, 2014.
[33] λrieh Iserles. A first course in the numerical analysis of differential equations. Number 44. Cambridge university press, 2009.
[34] λrthur Jacot, Franck Gabriel, and Clement Hongler. Neural tangent kernel: Convergence and generalization in neural networks. In Advances in neural information processing systems, pages 8571-8580, 2018.
[35] James Bradbury, Roy Frostig, Peter Hawkins, Matthew James Johnson, Chris Leary, Dougal Maclaurin, George Necula, Adam Paszke, Jake VanderPlas, Skye Wanderman-Milne, and Qiao Zhang. JAX: composable transformations of Python+NumPy programs, 2018.
[36] Lu Lu, Xuhui Meng, Zhiping Mao, and George E Karniadakis. DeepXDE: A deep learning library for solving differential equations. arXiv preprint arXiv:1907.04502, 2019.
[37] Oliver Hennigh, Susheela Narasimhan, Mohammad Amin Nabian, Akshay Subramaniam, Kaustubh Tangsali, Zhiwei Fang, Max Rietmann, Wonmin Byeon, and Sanjay Choudhry. Nvidia Simnet™: An ai-accelerated multiphysics simulation framework. In International Conference on Computational Science, pages 447-461. Springer, 2021.
[38] Sifan Wang, Hanwen Wang, and Paris Perdikaris. Learning the solution operator of parametric partial differential equations with physicsinformed DeepOnets. arXiv preprint arXiv:2103.10974, 2021.
[39] Sifan Wang and Paris Perdikaris. Long-time integration of parametric evolution equations with physics-informed deeponets. arXiv preprint arXiv:2106.05384, 2021.
[40] Sifan Wang, Hanwen Wang, and Paris Perdikaris. Improved architectures and training algorithms for deep operator networks. arXiv preprint arXiv:2110.01654, 2021.
[41] Zongyi Li, Hongkai Zheng, Nikola Kovachki, David Jin, Haoxuan Chen, Burigede Liu, Kamyar Azizzadenesheli, and Anima Anandkumar. Physics-informed neural operator for learning partial differential equations. arXiv preprint arXiv:2111.03794, 2021.
[42] Yifan Du and Tamer A Zaki. Evolutional deep neural network. arXiv preprint arXiv:2103.09959, 2021.
[43] Shashank Reddy Vadyala, Sai Nethra Betgeri, and Naga Parameshwari Betgeri. Physics-informed neural network method for solving one-dimensional advection equation using pytorch. Array, 13:100110, 2022.
[44] Suchuan Dong and Naxian Ni. A method for representing periodic functions and enforcing exactly periodic boundary conditions with deep neural networks. Journal of Computational Physics, 435:110242, 2021.
[45] N Sukumar and Ankit Srivastava. Exact imposition of boundary conditions with distance functions in physicsinformed deep neural networks. arXiv preprint arXiv:2104.08426, 2021.
[46] Lu Lu, Raphael Pestourie, Wenjie Yao, Zhicheng Wang, Francesc Verdugo, and Steven G Johnson. Physicsinformed neural networks with hard constraints for inverse design. arXiv preprint arXiv:2102.04626, 2021.
[47] Jesse Bettencourt, Matthew J Johnson, and David Duvenaud. Taylor-mode automatic differentiation for higherorder derivatives in jax. 2019.
[48] Dimitris C Psichogios and Lyle H Ungar. A hybrid neural network-first principles approach to process modeling. AIChE Journal, 38(10): 1499-1511, 1992.
[49] Xavier Glorot and Yoshua Bengio. Understanding the difficulty of training deep feedforward neural networks. In Proceedings of the thirteenth international conference on artificial intelligence and statistics, pages 249-256, 2010.
[50] Yoshiki Kuramoto and Toshio Tsuzuki. Persistent propagation of concentration waves in dissipative media far from thermal equilibrium. Progress of theoretical physics, 55(2): 356-369, 1976.
[51] Gregory I Sivashinsky. Nonlinear analysis of hydrodynamic instability in laminar flames—i. derivation of basic equations. Acta astronautica, 4(11): 1177-1206, 1977.
[52] Maziar Raissi. Deep hidden physics models: Deep learning of nonlinear partial differential equations. The Journal of Machine Learning Research, 19(1): 932-955, 2018.
[53] Michael Schaarschmidt, Dominik Grewe, Dimitrios Vytiniotis, Adam Paszke, Georg Stefan Schmid, Tamara Norman, James Molloy, Jonathan Godwin, Norman Alexander Rink, Vinod Nair, et al. Automap: Towards ergonomic automated parallelism for ml models. arXiv preprint arXiv:2112.02958, 2021.
[54] Khemraj Shukla, Ameya D Jagtap, and George Em Karniadakis. Parallel physics-informed neural networks via domain decomposition. arXiv preprint arXiv:2104.10013, 2021.
[55] Dmitrii Kochkov, Jamie A. Smith, Ayya Alieva, Qing Wang, Michael P. Brenner, and Stephan Hoyer. Machine learning-accelerated computational fluid dynamics. Proceedings of the National Academy of Sciences, 118(21), 2021.
[56] John D Hunter. Matplotlib: A 2D graphics environment. IEEE Annals of the History of Computing, 9(03): 90-95, 2007.
[57] Charles R Harris, K Jarrod Millman, Stéfan J van der Walt, Ralf Gommers, Pauli Virtanen, David Cournapeau, Eric Wieser, Julian Taylor, Sebastian Berg, Nathaniel J Smith, et al. Array programming with numpy. Nature, 585(7825): 357-362, 2020.
[58] Chelsea Finn, Pieter Abbeel, and Sergey Levine. Modelagnostic meta-learning for fast adaptation of deep networks. In International Conference on Machine Learning, pages 1126-1135. PMLR, 2017.
[59] Tobin A Driscoll, Nicholas Hale, and Lloyd N Trefethen. Chebfun guide, 2014.
[60] Steven M Cox and Paul C Matthews. Exponential time differencing for stiff systems. Journal of Computational Physics, 176(2): 430-455, 2002.

What is claimed is:

1. A method comprising:
training a physics-informed neural network using a plurality of training samples, wherein training the physics-informed neural network includes:
differentiating at least one partial differential equation characterizing a time-dependent behavior of a mechanical system; and
minimizing a loss function specifying an error of the physicsinformed neural network with respect to the training samples by assigning a plurality of weights in a residual loss value to account for physical causality in the partial differential equation; and
predicting, using the physics-informed neural network, movement of at least one component of the mechanical system.

2. The method of claim 1, wherein training the physics-informed neural network comprises iteratively training the physics-informed neural network over a plurality of training iterations.

3. The method of claim 2, wherein training the physics-informed neural network comprises using a gradient descent algorithm.

4. The method of claim 2, wherein training the physics-informed neural network comprises updating the plurality of weights in each iteration of the training iterations.

5. The method of claim 2, wherein, in at least one iteration of the training iterations, each of the weights in the residual loss value is inversely exponentially proportional to a magnitude of a residual from a previous iteration.

6. The method of claim 1, wherein differentiating the partial differential equation comprises using automatic differentiation.

7. The method of claim 1, wherein the partial differential equation characterizes one of: a conservation law, a diffusion process, an advection diffusion-reaction system, and a kinetic equation.

8. A system comprising:
at least one processor; and
a physics-informed neural network trainer implemented on the at least one processor and configured to perform operations comprising:
training a physics-informed neural network using a plurality of training samples, wherein training the physics-informed neural network includes:
differentiating at least one partial differential equation characterizing a time-dependent behavior of a mechanical system; and
minimizing a loss function specifying an error of the physics-informed neural network with respect to the training samples by assigning a plurality of weights in a residual loss value to account for physical causality in the partial differential equation; and
predicting, using the physics-informed neural network, movement of at least one component of the mechanical system.

9. The system of claim 8, wherein training the physics-informed neural network comprises iteratively training the physics-informed neural network over a plurality of training iterations.

10. The system of claim 9, wherein training the physics-informed neural network comprises using a gradient descent algorithm.

11. The system of claim 9, wherein training the physics-informed neural network comprises updating the plurality of weights in each iteration of the training iterations.

12. The system of claim 9, wherein, in at least one iteration of the training iterations, each of the weights in the residual loss value is inversely exponentially proportional to a magnitude of a residual from a previous iteration.

13. The system of claim 8, wherein differentiating the partial differential equation comprises using automatic differentiation.

14. The system of claim 8, wherein the partial differential equation characterizes one of: a conservation law, a diffusion process, an advection-diffusion-reaction system, and a kinetic equation.

15. A non-transitory computer readable medium storing executable instructions that when executed by at least one processor of a computer control the computer to perform operations comprising:
training a physics-informed neural network using a plurality of training samples, wherein training the physics-informed neural network includes:
differentiating at least one partial differential equation characterizing a time-dependent behavior of a mechanical system; and
minimizing a loss function specifying an error of the physicsinformed neural network with respect to the training samples by assigning a plurality of weights in a residual loss value to account for physical causality in the partial differential equation; and
predicting, using the physics-informed neural network, movement of at least one component of the mechanical system

16. The non-transitory computer readable medium of claim 15, wherein training the physics-informed neural network comprises iteratively training the physics-informed neural network over a plurality of training iterations.

17. The non-transitory computer readable medium of claim 16, wherein training the physics-informed neural network comprises using a gradient descent algorithm.

18. The non-transitory computer readable medium of claim 16, wherein training the physics-informed neural network comprises updating the plurality of weights in each iteration of the training iterations.

19. The non-transitory computer readable medium of claim 16, wherein, in at least one iteration of the training iterations, each of the weights in the residual loss value is inversely exponentially proportional to a magnitude of a residual from a previous iteration.

20. The non-transitory computer readable medium of claim 15, wherein differentiating the partial differential equation comprises using automatic differentiation.
